(19) United States
(12) Patent Application Publication
(10) Pub. No.: US 2010/0263345 A1
(43) Pub. Date: Oct. 21, 2010

(54) CUTTER-MIXER-FEEDER

(75) Inventors: Gershon Goldenberg, Petach Tikva (IL); Rafi Bivas, Jerusalem (IL); Yoav Koster, Haifa (IL)

Correspondence Address: THE NATH LAW GROUP, 112 South West Street, Alexandria, VA, 22314, US

(73) Assignee: LACHISH INDUSTRIES LTD., Sderot (IL)

(21) Appl. No.: 12/741,525

(22) PCT Filed: Nov. 5, 2008
(86) PCT No.: PCT/IL08/01456

§ 371 Date: May 5, 2010

Related U.S. Application Data
(60) Provisional application No. 60/996,165, filed on Nov. 5, 2007.

(51) Int. Cl. A01D 41/02; B02B 5/02; B02C 18/06; B02C 23/02; B02C 25/00; A01K 5/00; A01D 43/073; A01D 43/08; A01D 41/127

(52) U.S. Cl. 56/10.2 R; 241/101.71; 241/101.8; 241/277

(57) ABSTRACT

Provided is a cutter-mixer-feeder (CMF) for producing, transporting and discharging fodder. The CMF includes a mobile platform, a chopper assembly for harvesting at least one raw material and production of fodder, a container for receiving at least one of the raw material and fodder, at least one auger for chopping and mixing the fodder, at least one conveyer belt for discharging the fodder to livestock, a drive unit for providing power for at least one of the above; and a control system. Based on the data, the control system is adapted to dynamically match power distribution of the drive unit to any one of the above elements relative to the desired load exerted thereon. The mobile platform has first and second wheel axles for individual and independent manipulation by the control system. The chopper assembly has an elongated chopper member having a central axis and fitted with a spiral blade extending around a central axis. The chopper member has a non-uniform pitch. The distances between adjacent blade portions of the spiral blade increase inwardly to axially accelerate loose material from respective ends of the elongated chopper member towards a central portion thereof.

### FIELD OF THE INVENTION

The present invention relates to cutter-mixer-feeders for processing livestock feed material. More particularly the invention is concerned with a total management computerized controlled loading-mixer-feeder (also referred to as cutter-mixer-feeder).

### BACKGROUND OF THE INVENTION

It has long been known in livestock feeding to blend nutritive ingredients of the feed in a mixer, either stationary or mobile. A typical mixer contains augers, blades and other types of mixing components which are intended to operate on the ingredients of the feed to cut long fiber materials and to mix them into a substantially homogeneous mass and on demand to assist in conveying and discharging the feed from the mixer so that all animals fed from the batch in the mixer will be provided a substantially uniform ration content.

It has been found that uniformity of the feeding blend, total mix ration (TMR), is essential in livestock nutrition resulting in increased milk produce and controlled animal health.

A variety of mixer feeder wagons are known in the art for processing livestock feed material. One such wagon is disclosed in U.S. Pat. No. 6,945,485.

European Patent Application No. EP0963970 discloses a cutter-mixer-feeder vehicle for treating materials suitable for producing compost, comprising a container with one or more internal screw feeders equipped with blades for cutting the material to be treated and a lifting device which collects the material to be treated placed outside the wagon and arranges it on a conveyor belt which transfers it into the container. The lifting device comprises a screw feeder on top of which there is a revolving shaft, supported by a casing and provided with blades for cutting and loading the material onto the conveyor belt.

Also known are various improvements in components of mixer-feeders. One such improvement is disclosed in U.S. Pat. No. 5,443,588 which is directed to a screw feeder fitted within a container of a cutter-mixer-feeder for fodder and grass or straw materials; said screw feeder is placed at the bottom of said container and provided with at least a pair of spirals, one of which is rolled up clockwise, while the other counterclockwise. In the substantially central area of the screw feeder where said spirals meet, they set out a discoidal element consisting of a right half spiral and a left half spiral, each of which has at least one outlet which is obtained by taking away a part of the half spiral itself.

### SUMMARY OF THE INVENTION

It is an object of the present invention to provide a totally managed, computer controlled, self propelled, self loading cutter-mixer-feeder (herein after referred to also as CMF). A device according to the present invention yields accurately blended livestock feed, the ingredients of which are chopped to an optimal size without deteriorating its nutritive values, and where the overall power consumption of the device is significantly reduced as well as the turnover time of a cycle of operation.

According to one aspect of the present invention there is provided a cutter-mixer-feeder (CMF) adapted for producing, transporting and discharging fodder comprising:
a) a mobile platform;
b) a chopper assembly for harvesting at least one raw material and for production of fodder therefrom;
c) a container for receiving at least one of said raw material and said fodder;
d) at least one auger for chopping and mixing said fodder;
e) at least one conveyer belt for discharging said fodder to livestock;
f) a drive unit adapted for providing power for at least one of the above elements (a) to (e); and
g) a control system comprising a controller connected to said drive unit and at least one sensor attached to at least one of the elements (b) to (f) to receive data therefrom;
   Wherein, based upon said data, said control system is adapted, using said controller, to dynamically match power distribution of the drive unit to any one of elements (a) to (e) relative to the desired load exerted thereon, such that none of these elements exceeds the maximum power consumption as pre-defined for each operation.

According to another aspect of the present invention there is provided a cutter-mixer-feeder (CMF) adapted for producing, transporting and providing fodder comprising a mobile platform, and at least one of the following:
a) a chopper assembly for harvesting at least one raw material and for production of fodder therefrom;
b) a container for storing at least one of said raw material and said fodder;
c) at least one auger for chopping and mixing said fodder;
d) at least one conveyer belt for distributing said fodder to an end user;
e) a drive unit adapted for providing power for at least one of the above elements (a) to (e); and
f) a control system connected to said drive unit and adapted for monitoring operation of said mobile platform and at least any one of said elements (a) to (e);
   Wherein, said mobile platform comprises at least a first wheel axle and a second wheel axle adapted for individual and independent manipulation by said control system.

According to a further aspect of the present invention there is provided a cutter-mixer-feeder (CMF) adapted for producing, transporting and providing fodder comprising:
a) a mobile platform;
b) a chopper assembly for harvesting at least one raw material and for production of fodder therefrom;
c) a container for storing at least one of said raw material and said fodder;
d) at least one auger for chopping and mixing said fodder;
e) at least one conveyer belt for distributing said fodder to an end user; and
f) a drive unit adapted for providing power for at least one of the above elements (a) to (e);
   Wherein, said chopper assembly comprises an elongated chopper member having a central axis and fitted with a spiral blade extending therealong around said central axis, and having a non-uniform pitch, wherein the distances between adjacent blade portions of said spiral blade increases inwardly, to thereby axially accelerate loose material from respective ends of said elongated chopper member towards a central portion thereof.

Each of the above aspects of the present invention may assume any one or more of the following features:

Said CMF may be adapted for performing at least one of the following cycles:
i. a loading cycle for obtaining raw material and producing fodder therefrom;
ii. a mixing cycle for mixing said fodder; and
iii. a discharge cycle for distributing said fodder to said livestock.

Said CMF may be designed such that at least two of the cycles (i) to (iii) are performed simultaneously.

Said control system may be provided with a central processor so as to provide real time diagnosis of different parameters of the elements (a) to (e). In addition, by virtue of the control system, said chopper assembly may be adapted to receive power priority during said loading cycle, and said auger may be adapted to receive power priority during said mixing cycle.

Said control system may further be adapted for regulating the RMP of the chopper assembly and auger according to respective density of said raw material and fodder.

Said CMF may also comprise a weighing mechanism articulated to said container and connected to said control system, and adapted for regulating the amount of at least one raw material received within said container for production of fodder therefrom. Said control system may be adapted for regulating said weighing mechanism according to the allowed load of material on the conveyer belt.

Said control system may also be adapted for receiving input in the form of a recipe specifying a desired amount for one or more of said raw material and/or said fodder and/or at least one nutritive ingredient, and regulate operation of the chopper assembly accordingly, to load/harvest the desired amount of each raw material. During loading/harvesting of said raw material by said chopper assembly, said control system may further be adapted to automatically cut-off/continue operation of said chopper assembly according to respective sufficient/insufficient desired amount of said raw material.

Said chopper assembly may comprises a chopper arm articulated at a proximal end of said mobile platform and equipped at a distal end thereof with an elongated chopper member extending along a central axis. Said elongated chopper member may be fitted with a spiral blade extending therealong around said central axis, and having a non-uniform pitch, wherein the distances between adjacent blade portions of said spiral blade increase inwardly, to thereby axially accelerate loose material from respective ends of said elongated chopper member towards a central portion thereof.

Said elongated chopper member may also be fitted with at least one directing blade so as to impart raw material with acceleration in a radial direction towards the conveyer belt.

Said chopper assembly may comprise, in addition, a housing articulated to the chopper arm and formed at its back wall with an aperture for material passage onto the belt conveyer. Said housing may be further fitted at its top fore end with a pivotable deflector, whereby upon rotation of the elongated chopper member, loose material is prevented from escape away from the chopper assembly. Said housing may also be fitted at its inner surface with at least one directing blade for directing loose material chopped by the elongated chopper member towards a central portion thereof.

Said mobile platform may comprise a front wheel axle and a rear wheel axle, each of said wheel axles being individually, and independently controlled by said control system.

### BRIEF DESCRIPTION OF THE DRAWINGS

In order to understand the various aspects invention and to see how it may be carried out in practice, some features of the invention will now be described, by way of a non-limiting example only, with reference to the accompanying drawings, in which:

FIG. 1 is a top perspective view of a loading-mixer-feeder according to the present invention, with the chopper deflector removed and with the chopper arm at a lowermost position;

FIG. 2 is a left-side perspective view of a loading-mixer-feeder according to the present invention with the chopper arm partially elevated;

FIG. 3 is a left-side perspective view of a loading-mixer-feeder according to the present invention with the chopper arm at an elevated position;

FIG. 4 is a right-side perspective view of a loading-mixer-feeder according to the present invention with the chopper arm at an elevated position

FIG. 5 is a perspective view of the chopper;

FIG. 6A is front perspective view of the chopper housing without the deflector and without the chopper;

FIG. 6B is front view of the chopper housing without the deflector and without the chopper; and

FIGS. 7A to 7C are respective left, front and top elevations of a loading-mixer-feeder according to another design of the present invention.

### DETAILED DESCRIPTION OF THE INVENTION

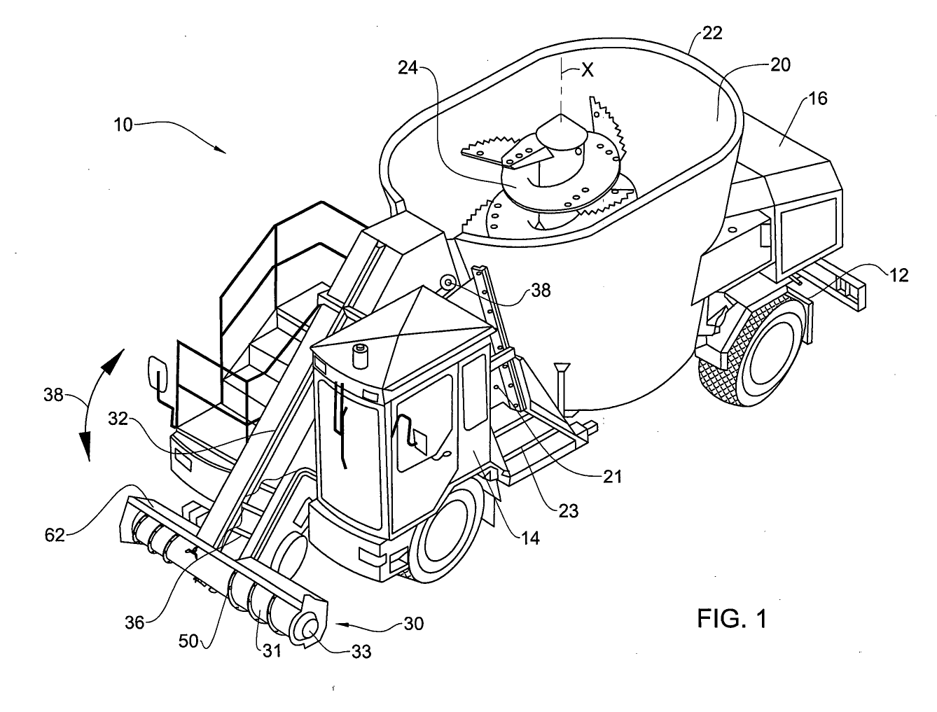

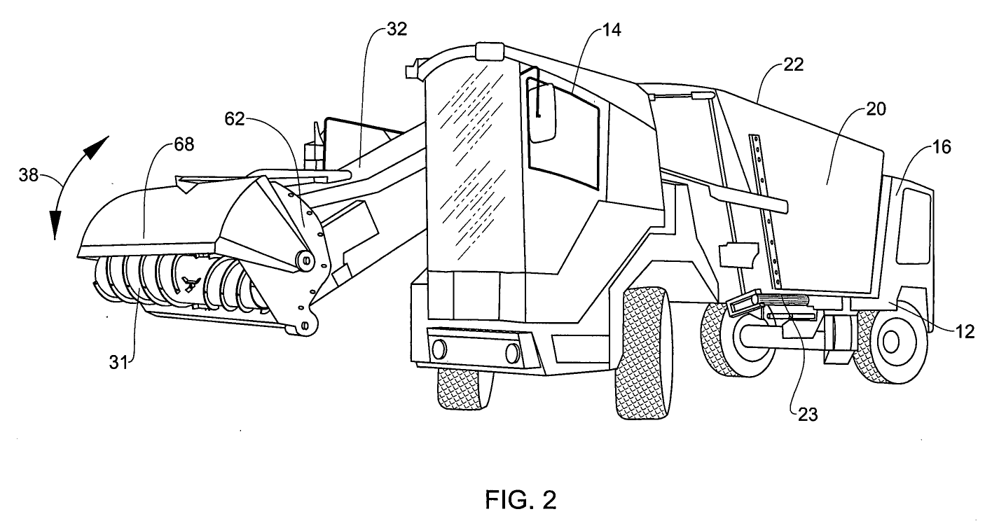

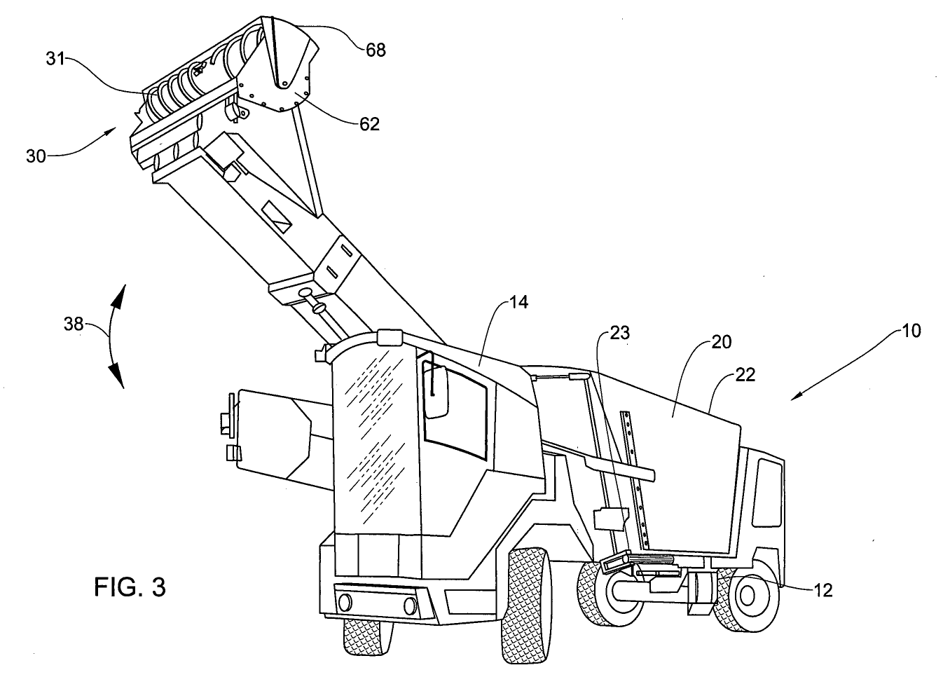

Attention is first directed to FIGS. 1 to 4 of the drawings illustrating a cutter-mixer-feeder in accordance with the present invention generally designated 10 of the type comprising a wheeled vehicle platform 12, an operator's cabin 14, power unit 16 for supplying all the power needs of the wagon, namely for locomoting the platform and for cropping, processing and discharging/dispensing the feed material, as will be discussed hereinafter.

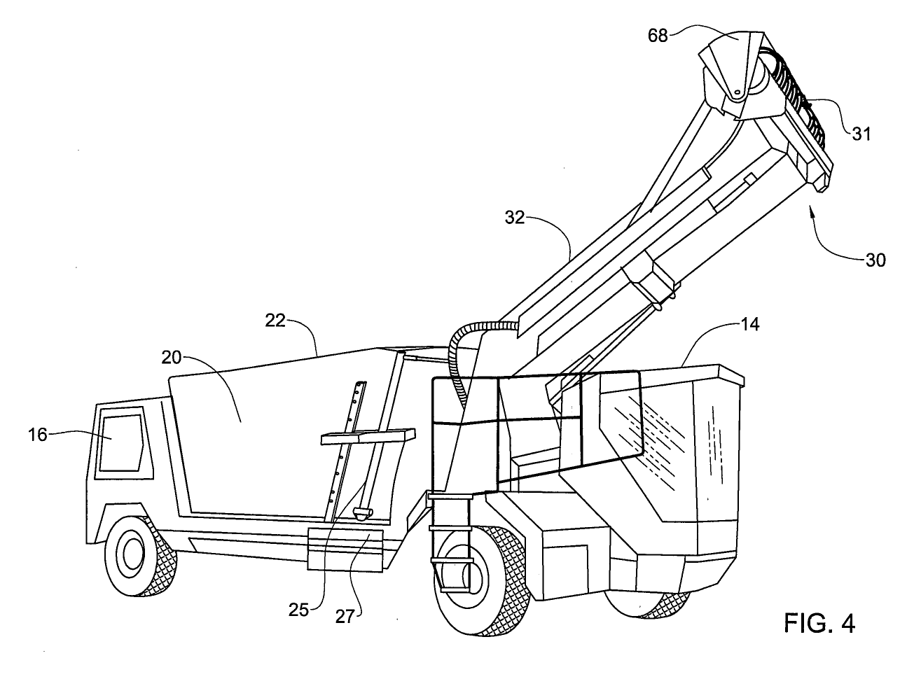

The cutter-mixer-feeder wagon 10 (CMF wagon) further comprises a large container 20 formed with a top opening 22 and fitted with an auger 24 mounted on a central axis X vertically extending within the container 20. It is however appreciated that more then one auger may be provided, depending on the size of the container. A discharge opening is formed at a lower part of the container 20 with a discharge door 21 and a discharge conveyer belt 23 is provided for discharging fodder to livestock, e.g. to feeding troughs. Discharge of the ready food material takes place at the left side of the wagon, such that the operator can best maneuver it to discharge the fodder accurately. It is however noted that a right-side door 25 and a respective discharge conveyer belt 27 are provided as well (FIG. 4).

A chopper assembly generally designated 30 comprises a cylindrical chopper 31 rotatable about a chopper axis 33 and is supported at a fore end of a chopper arm 32 in the form of a closed duct with a conveyer belt 36 (seen at a partially sectioned portion at a fore and of the arm 32 in FIG. 1). Said conveyer belt 36 (also referred to in the art as an ‘elevator’) extending from the chopper assembly 30 towards the open end 22 of the container 20, to thereby convey material from the chopper assembly 30 into the container 20. It is noted that the chopper arm 32 is pivotally supported about a pivot axis 38 (adjacent the container 20) such that the chopper arm and the chopper assembly 30 are pivotally displaceable along arrow 38. FIGS. 1, 2 and 3 illustrate the chopper arm 32 at three positions, namely lowermost, intermediate and uppermost, respectively.

The CMF wagon 10 in accordance with the present invention is fitted with a powerful control system comprising a plurality of sensors for pick-up of various data information corresponding with measured parameters and transferring same to a local processor (computer system) fitted on the wagon which in turn generates a series of control signals as will be discussed hereinafter in detail.

The CMF wagon 10 has two major operating modes namely, travel/locomotive mode in which the CMF wagon travels along a path or road, and a farm mode. The farm mode includes several work cycles, as follows:
a loading cycle wherein the CMF chops different livestock nutritive ingredients such as silage, powder material, grains hay, straw and the like (generally referred to a long-fiber products). from a heap of material, upon which the harvested material is chopped by the chopper assembly 30 and is conveyed into the container 20;
a mixing cycle wherein a plurality of ingredients are mixed within the container by the auger 24 to thereby yield a high quality fodder. The term ‘crop’ as used in the specification is commonly used in the art to describe the act of collecting/cropping of long fiber material; it is appreciated that the mixing cycle may take place whilst the CFM is still at the loading cycle;
a discharge cycle wherein the wagon travels along feed troughs (e.g. of a livestock barn) to discharge the processed fodder, whilst the auger 24 keeps rotating.

The arrangement is such that power consumption from the power unit 16 is logically distributed depending on a current operating cycle and however, remaining the output of the power unit within the range of between approximately 80% to 90% of its power output, to thereby prevent cut-off of the power unit, and to maintain a substantially efficient cycle of operation.

Accordingly, during the loading cycle, the chopper assembly 30 is a primer consumer of power generated by the power unit 16. As the CMF wagon 10 travels within a restricted operating area (typically forwards and backwards while “biting” into a heap of straw, silage, or the like), the chopper arm 32 is pivotally displaced to gain access to a heap of straw whilst the conveyer belt 36 is active to convey the chopped material into the container 20. During the loading cycle the auger 24 has first priority on power withdrawal from the power unit, and mixing auger reduced RPM according to the maximum allowed power.

As already mentioned above, the CMF wagon is fitted with a plurality of control sensors including, among others, a chopper sensor assembly comprising a chopper pressure sensor fitted on the induced pressure line and/or on a chopper axle 33, whereby the power transmitted to the chopping assembly 30 dynamically changes depending on load induced pressure by the material chopped. Accordingly, for light material such as straw, hay and the like, the chopper 31 rotates at essentially high RPM though consuming low power, that noting the potentially low resistance of the chopped material. For that purpose, at least two pressure sensor assemblies are provided, one fitted on the chopper high pressure line and/or on axle 33 and the other fitted on the high pressure line and/or on the axle of the auger 24.

The arrangement is as such that during a loading cycle (chopping mode) the chopper 31 has power consuming priority to thereby obtain best chopping performance by reducing the revolving RPM of the auger 24.

Furthermore, there is an override mechanism to prevent overloading of the chopper or any other mechanical elements of the system by an operator. For that purpose, a plurality of pressure sensors ensure that the output moment of the chopper does not reach the maximum permitted load, depending on a respective signal received from the pressure sensors.

Clogging or arresting of the chopper 31 during a chopping process (i.e. upon “biting” into a heap of straw material) may eventually result in cut off of the power unit. In such a case, it is common practice in the art to disengage the chopper from the heap by forwards/backwards maneuvering of the wagon, or by elevating/lowering the chopper arm or by inverting direction of rotation of the chopper. These are time consuming procedures as well as power consuming procedures which in accordance with the present invention are avoided since maximum power output is directed towards the chopper 31 (since at this cycle only minimal required power is transmitted to the auger 24 or to the locomoting assembly of the platform 12)

Thus, the arrangement according to the present invention is such that the control system governs the load of each of the operating components (e.g. chopper assembly, auger and vehicle platform), namely controlling the moment and the maximal RPM, to thereby ensure that these components do not exceed the maximum power consumption as designed for each operation. Accordingly, the load applied by the auger is reduced depending on the power consumed by the chopper assembly 30 as mentioned hereinabove. Likewise, during a loading cycle (farm mode) the CFM wagon 10 travels at an essentially low speed and at low power consumption.

The provision of the pressure sensors responsive to pressure over the chopper 31 governs also the speed of elevation/lowering of the chopper arm 32 as well as the speed of rotation of the chopper 31 such that the operator of the CFM cannot override the system so as to ensure smooth and continuous operation of the device however with minimal time and energy consumption.

According to a particular embodiment of the invention the speed of the chopper 31 is prioritized to be maintained at constant speed over elevation/lowering of chopper arm 32.

During a discharge cycle, i.e. after all the ingredients have been loaded into the container 20 and the auger 24 has chopped and mixed these ingredients to a desired and well controlled state, the CFM wagon 10 travels towards a discharge area, typically feeding troughs of the livestock. During such traveling, the auger 24 keeps rotating and upon reaching the discharge site, the discharge door 21 opens and the discharge conveyer belt 23 is engaged into operation to thereby discharge the fodder into said troughs.

The CFM wagon 10 has two primary working modes one being a so-called “road mode” namely an ‘automotive controlled mode’ intended for fast motion of the wagon, and the other the ‘farm mode’, being an operator controlled travel e.g. at the facilities of the barn and upon discharging fodder. However, during farm mode (i.e. during a loading cycle or a discharge cycle) the motor of the CFM wagon will not exceed the nominal RPM recommended by the manufacturer thereof so as to maintain an optimal fuel consumption. According to a particular embodiment of the invention the motor will operate at 1700 RPM.

It is in interest of the farmer to reduce to minimum the overall feeding cycle period, i.e. reduce the overall time required for chopping, mixing, traveling and discharging the fodder, however whilst maintaining fodders quality and at minimal energy consumption.

Further chopping of the ingredients fed into the container 20 takes place upon revolving of the auger 24 which simultaneously mixes the ingredients. However, it is required not to lose notorious qualities of the fodder mixture by over chopping the long-fiber ingredients. Thus, a control assembly in the form of pressure sensors is provided on the motor and/or on the axle of the auger 24 to thereby reduce the RPM of the auger upon decrease of the load sensed over the axle of the auger 24. Furthermore, the revolving speed of the auger 24 may be continuously monitored and controlled by the operator of the wagon and even more so a maximum revolving speed may be set. Controlling these parameters results in reducing the overall cycle time, reduction of energy consumption and controlled fiber length.

Contrary to constant-speed revolving augers, the auger in accordance with the present invention revolves at alternating speed depending on the current operating cycle and in combination with the condition of the mixture within container 20. Thus, whilst the CFM wagon 10 has completed loading all fodder ingredients and travels towards the feeds troughs, the RPM of the auger is reduced to a minimum in order to prevent over-chopping of the fibers beyond a minimal effective length, and further in order to reduce the total energy consumed. If, during the traveling stage, the CFM wagon 10 has stopped for some reason, e.g. for repairing a flat tire or if access to the dairy barn is blocked for some reason, over-chopping of the fibers will not occur owing to automatic reducing the revolving speed of the auger 24.

Accordingly, once the automatic mixing cycle is completed and the fodder has been chopped and mixed to the desired extent, the auger's RPM is reduced to a minimal RPM, that is to maintain the fodder at a homogeneous mixed state without further chopping of the fibers. Noting that the fodder may be at damp/wet condition, continuous rotation of the auger is required, though at low RPM (e.g. 1 to 2 RPM) in order to prevent the fodder from sticking.

At a cleaning state, when it is required to clean the container 20 and discharge ingredients from the auger 24, the auger is revolved at high RPM (e.g. at about 50 RPM) to thereby discharge material from the flightings and chopping/mixing blades, whereby centripetal forces assist in discharging material from the flightings and blades.

Maintaining a low speed rotation of the auger 24 while traveling with a loaded container prevents the mixed material from becoming bulk and maintains it at a fluffy state. This is also important since during traveling the mixture may become tightened (compressed) under its self weight owing to bouncing of the wagon during its travel. As already mentioned hereinabove, the device of the present invention is a so-called total energy managed wagon and is thus fitted with a plurality of load and pressure sensors such that energy to the various power consuming assemblies is transferred only upon actual demand of these assemblies and mechanisms, depending on control signals emitted from various sensors fitted in said mechanisms and assemblies. This arrangement thus provides that power supply to operated units and assemblies is dynamic and continuously changes according to demand and operating cycle, that as opposed to on/off type assemblies operating at fixed speeds and power outputs.

It is well known that milk production is highly dependent on the quality of the fodder and to a great extent also on maintaining fixed optimal parameters, namely supplying regular food batches. It is appreciated that the significant expense at a dairy barn is the food stuff and it is for these reasons that it is desired to supply the livestock with food batches nearing to a nutritionists recommendations, which also have significant implications on the livestocks health.

In order to ensure a fixed discharged fodder batch, the container 20 is mounted on a weighing mechanism. The operator enters into the controller the recommended portion of each of the fodder ingredients, by entering the relative mass thereof. In a fully automatic and computer-controlled mechanism, without any input by the operator, the system constantly calculates the relative weight of each ingredient fed into the container 20, as it is loaded from each specific loading station, namely chopping of material by the chopper 31. Accordingly, when the weighing system generates a mass signal corresponding with the weight of a specific loaded ingredient, the chopping speed of chopper 31 is reduced along with slowing the conveyer belt 36. When the weighing system generates a signal indicating that a certain ingredient has been completely loaded, the chopper 31 stops and the belt conveyer 36 now moves in an opposite direction to discharge any residual material remaining thereon, so as to prevent introduction of excessive material into the container 20.

The arrangement is such that the controller of the CFM wagon 10 is pre-loaded with the recipe of the fodder mixer such that the system recognizes the relative weight of each ingredient in the fodders' recipe. Such information may be manually fed into the controller or by wireless means or otherwise, such as to allow versatility of the nutritive parameters depending on specific requirements of the dairy barn, depending on feedings of the year, type of livestock, etc.

Thus, as concluded from the above, the system is completely automatic and no input of the operator is required, unlike some systems in which an alert signal indicates to the operator to cease chopping a certain ingredient. In the particular invention, the operator receives a signal indicating that chopping (loading) of a particular ingredient has completed and that the CFM wagon 10 is now to travel to another loading station to load another ingredient. However, at the event that a certain ingredient was not completely loaded into the container 20, namely the particular ingredient did not reach its required mass, a constant alert appears, indicating to the operator that that particular ingredient is still to be completed into the container.

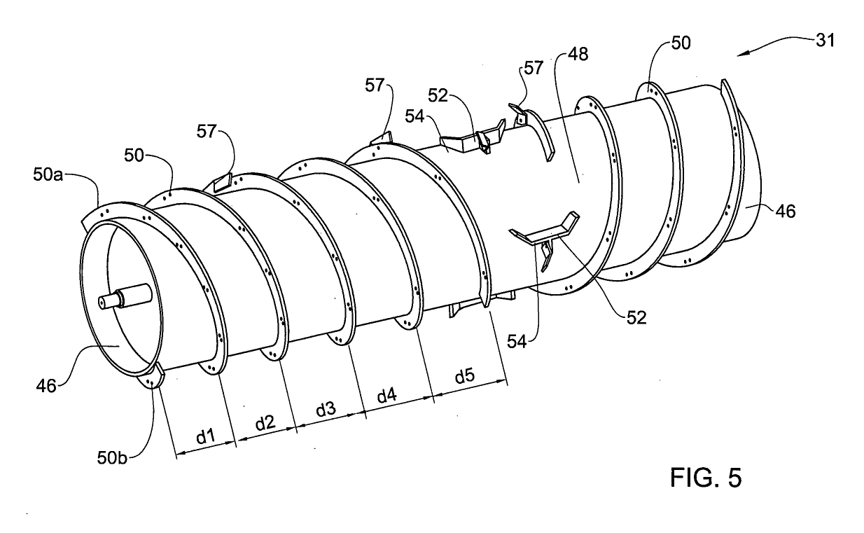

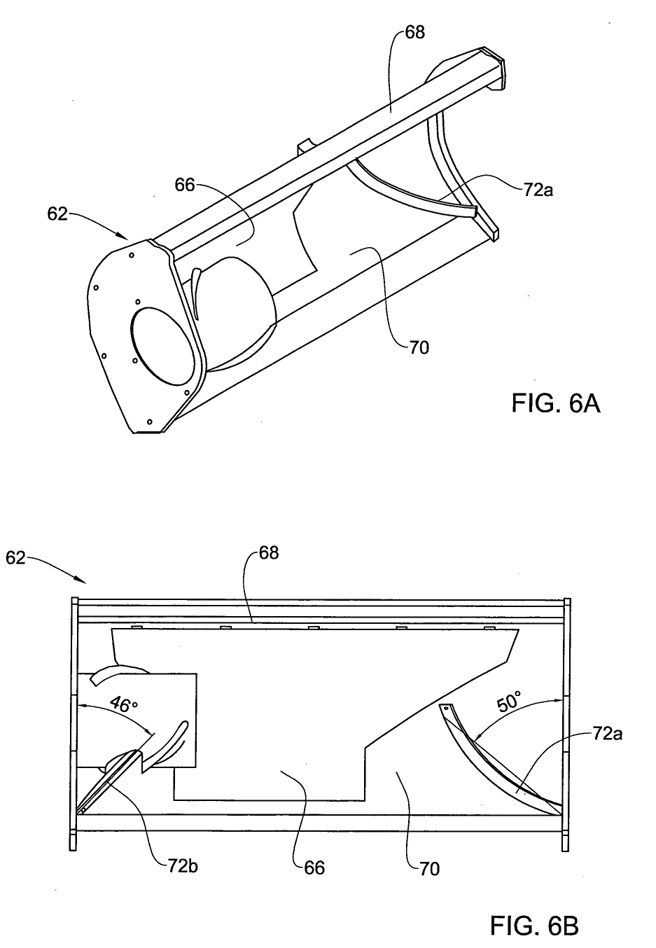

As already mentioned hereinabove, it is desired to reduce the overall time required for completing a feeding cycle including collecting material, chopping, mixing, discharging and traveling. In this regard, the CFM of the present invention is designed to perform a feeding sequence at minimal time as a result, among other, of the following features:
1) The loading time is reduced by fast chopping obtained by a chopper 31 fitted with a non-uniform pitch wherein the distances d1, d2, d3, d4, d5 (FIG. 5) are non-uniform, i.e. the distance increases inwardly, to thereby accelerate loose material from the respective ends 46 of the chopper 31 towards the central portion 48 where said material is introduced onto the conveyer belt 36. According to a particular embodiment the arrangement ma be such that d1=d2<d3=d4<d5 Furthermore, as noted in FIG. 5, the threading of the chopper 31 comprises two starts 50a and 50b whereby a double amount of material is propelled along the coiled chopper 31 towards the central portion 48.
2) The chopper 31 is fitted with several directing blades 52 and 54 so as to impart the material with acceleration in a radial direction towards the conveyer belt 36. This arrangement prevents clogging of material at the central portion 48 in spite of the substantially fast propelling of material from the ends 46 towards the central portion 48. Axial direction blades 57 are provided too for that purpose.
3) The chopper assembly 30 comprises a housing 62 articulated to the chopper arm 32 and formed at its back wall 64 with an aperture 66 (FIGS. 6A and 6B) for material passage onto the belt conveyer 36. The housing 62 is fitted at its top fore end with a pivotable deflector 68 whereby upon rotation of the chopper 31, loose material does not escape away from the chopper assembly 30 but rather drops back into the chopper assembly 30 to be directed through the central portion 48 and onto the elevator (conveyer belt 36). Without such a deflector a significant amount of loose material scatters, having two effects, namely one reducing the chopping efficiency of the CFM and other resulting in a non-environmental arrangement where more dust spreads around.
4) Furthermore, the housing 62 is fitted at its inner surface 70 with several directing blades 72a and 72b (best seen in FIGS. 6A and 6B) for directing the loose material chopped by the chopper 31 towards the central portion of the chopper 31 and respectively towards the collecting opening 66 formed at the housing 62. These directing blades 72a and 72b extend opposite the spiral blades 50 of the chopper 31 (FIG. 5) for ensuring that the material is forced to pass between the respective directing blades 72 and blades 50 of the chopper for improving the flow of chopped material towards the central portion as mentioned hereinabove, whilst loosening the material and pre-chopping it.
5) For different types of material to be chopped by chopper 31, different revolving speed is used, to thereby increase chopping efficiency. This is found useful in shortening the chopping cycle time, increasing power consumption efficiency and eliminating or substantially reducing the amount of dust and loose material scattered at the chopping area. This is useful in light of the ever growing environmental requirement. The different speeds used for each material reduces the dust in that over chopping is less likely to occur and in the long run this also amounts to less material being lost.
6) As already being mentioned hereinbefore, the auger 24 will revolve at different RPM depending on the load which is a resultant of the weight of material received within container 20 and the type of material (amount of wet ingredients and of long fiber material). Accordingly, the auger 24 will revolve fast at an initial stage when the load is low to thereby fast chop and mix the material and at a later stage, upon further loading of the container 20, the revolving speed of the auger 24 significantly reduces. It is thus an aim that the revolving speed of auger 24 be kept optimal to prevent overloading of the power unit on the one hand and, on the other hand, to consume minimal required energy whilst maintaining the longer fibers at their optimal size depending on nutritionist parameters as predefined. This arrangement ensures that mixing of the fodder mixture is practically completed upon completing loading of the container 20 whereby the CFM wagon 10 can directly travel towards the feeding trough without wasting any further time on a mixing process. As soon as chopping and filling of the container is complete the CFM travels towards the barns and discharges the material into the feeding trough.
7) It is still a feature of the CFM according to the present invention that the most efficient and maximal nutritive value of the food mixture is maintained without destroying its nutritive qualities of methods e.g. by over chopping of the long fiber material by the chopper or auger. This is owing to the alternating speed which is pre-selected and programmed for each type of food ingredient, whereby the central control unit of the CFM generates an appropriate signal corresponding with a specific type of ingredient chopped by the chopper 31. Even more so, the central processing unit controls the speed of the auger 24, depending on the moist contained within the mixture and the ingredients supplied into the container 22 to thereby obtain a homogeneous food mixture and not deteriorate the fodder stuff by over chopping of the long fiber material.
8) Amongst other features of the CFM subject of the present invention, there is a real time machine diagnostics system wherein a central processor continuously provides data concerning different parameters of the equipment which information may be kept in a log and also be transferred at real time (wireless communication) to a control center.
9) Still another feature of the CFM wagon subject of this invention is its maneuvering system which is designed for improving the cycle time by efficient steering. For that purpose the steering system of the wheel platform is either a four-wheel drive system or a two-wheel drive system, whereby efficient (reduced likelihood of skidding) and minimum maneuvering radius is obtained such that the CFM can efficiently maneuver also at tight areas. Accordingly, the pair or rear wheels either maintained their straight, aligned position whilst the front wheels turn, or the pair of rear wheels turns at an opposite direction to that of the front wheels or, the pair of rear wheels turns at the same direction as that of the pair of front wheels, depending on direction of maneuvering of the vehicle and the maneuver required.

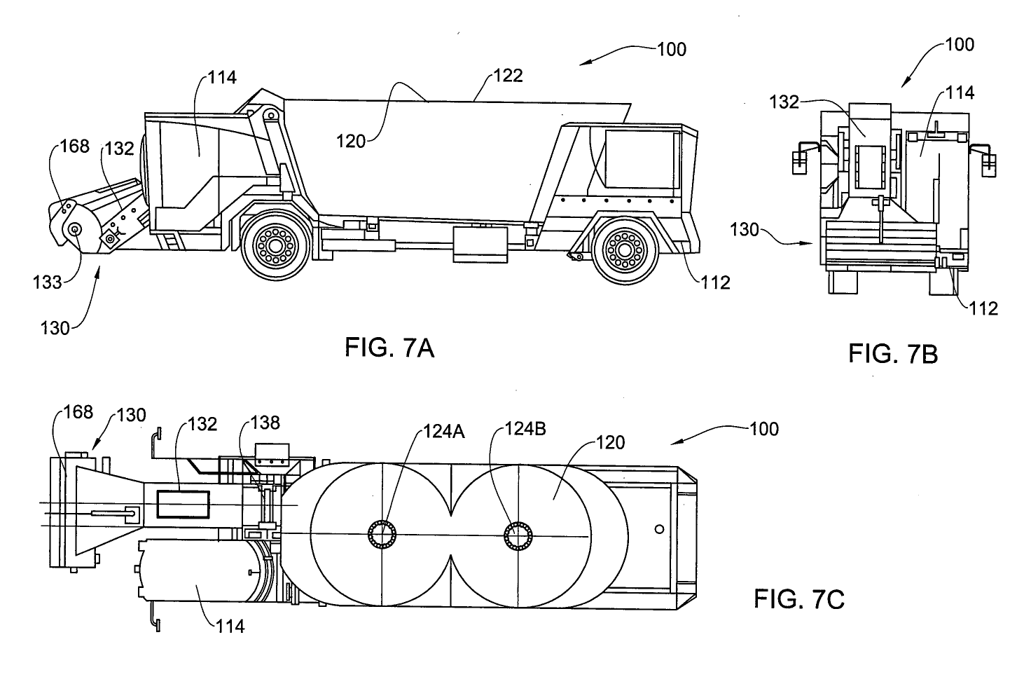

With further reference to FIGS. 7A to 7C there is illustrated a CFM wagon according to a different design of the present invention, designated 100. for sake of clarity and ease of identifying elements thereof, like reference numbers have been designated as in the previous drawings, however shifted by 100. From the drawings it is noticeable that the main difference between the previous embodiment and the embodiment of FIGS. 7A to 7C and resides in that the later is a larger platform fitted with a large container 130 and two augers 124A and 124B.

Those skilled in the art to which this invention pertains will readily appreciate that numerous changes, variations, and modifications can be made without departing from the scope of the invention, mutatis mutandis.

1.-53. (canceled)

54. A cutter-mixer-feeder (CMF) configured for producing, transporting and discharging fodder comprising:
(a) a mobile platform;
(b) a chopper assembly for harvesting at least one raw material and for production of fodder therefrom;
(c) a container for receiving at least one of the raw material and the fodder;
(d) at least one auger for chopping and mixing the fodder;
(e) at least one conveyer belt for discharging the fodder to livestock;
(f) a drive unit configured for providing power for at least one of the above elements (a) to (e); and
(g) a control system comprising a controller connected to the drive unit and at least one sensor attached to at least one of the elements (b) to (f) to receive data therefrom;
wherein, based upon the data, the control system is configured, using the controller, to dynamically match power distribution of the drive unit to any one of elements (a) to (e) relative to the desired load exerted thereon, such that none of these elements exceeds the maximum power consumption as pre-defined for each operation.

55. The CMF according to claim 54, wherein the CMF is configured for performing at least one of the following cycles:
(i) a loading cycle for obtaining raw material and producing fodder therefrom;
(ii) a mixing cycle for mixing the fodder; and
(iii) a discharge cycle for distributing the fodder to the livestock.

56. The CMF according to claim 55, wherein at least two of the cycles (i) to (iii) are performed simultaneously.

57. The CMF according to claim 54, wherein the control system is provided with a central processor so as to provide real time diagnosis of different parameters of the elements (a) to (e).

58. The CMF according to claim 55, wherein, by virtue of the control system, the chopper assembly is configured to receive power priority during the loading cycle, and the auger is configured to receive power priority during the mixing cycle.

59. The CMF according to claim 54, wherein the control system is configured to regulate the RMP of the chopper assembly and auger according to respective density of the raw material and fodder.

60. The CMF according to claim 54, wherein the CMF further comprises a weighing mechanism articulated to the container and connected to the control system, and configured for regulating the amount of at least one raw material received within the container for production of fodder therefrom.

61. The CMF according to claim 60, wherein the control system is configured to regulate the weighing mechanism according to the allowed load of material on the conveyer belt.

62. The CMF according to claim 61, wherein the control system is configured for receiving input in the form of a recipe specifying a desired amount for one or more of the raw material and/or the fodder and/or at least one nutritive ingredient, and regulate operation of the chopper assembly accordingly.

63. The CMF according to claim 61, wherein the control system, during harvesting of the raw material by the chopper assembly, is configured to automatically cut-off/continue operation of the chopper assembly according to respective sufficient/insufficient desired amount of the raw material.

64. The CMF according to claim 54, wherein the chopper assembly comprises a chopper arm articulated at a proximal end to the mobile platform and equipped at a distal end thereof with an elongated chopper member extending along a central axis.

65. The CMF according to claim 64, wherein the chopper assembly comprises an elongated chopper member extending along a central axis and fitted with a spiral blade extending therealong around the central axis, and having a non-uniform pitch, wherein the distances between adjacent blade portions of the spiral blade increases inwardly, to thereby axially accelerate loose material from respective ends of the elongated chopper member towards a central portion thereof.

66. The CMF according to claim 65, wherein the elongated chopper member is fitted with at least one directing blade so as to impart raw material with acceleration in a radial direction towards the conveyer belt.

67. The CMF according to claim 64, wherein the chopper assembly further comprises a housing articulated to the chopper arm and formed at its back wall with an aperture for material passage onto the belt conveyer.

68. The CMF according to claim 67, wherein the chopper assembly further comprises a housing fitted at its top fore end with a pivotable deflector, whereby upon rotation of the elongated chopper member, loose material is prevented from escape away from the chopper assembly.

69. The CMF according to claim 68, wherein the housing is fitted at its inner surface with at least one directing blade for directing loose material chopped by the elongated chopper member towards a central portion thereof.

70. The CMF according to claim 54, wherein the mobile platform comprises a front wheel axle and a rear wheel axle, each of the wheel axles being individually, and independently controlled by the control system.

71. A cutter-mixer-feeder (CMF) configured for producing, transporting and providing fodder comprising a mobile platform, and at least one of the following:
(a) a chopper assembly for harvesting at least one raw material and for production of fodder therefrom;
(b) a container for storing at least one of the raw material and the fodder;
(c) at least one auger for chopping and mixing the fodder;
(d) at least one conveyer belt for distributing the fodder to an end user;
(e) a drive unit configured for providing power for at least one of the above elements (a) to (e); and
(f) a control system connected to the drive unit and configured for monitoring operation of the mobile platform and at least any one of the elements (a) to (e);
wherein, the mobile platform comprises at least a first wheel axle and a second wheel axle configured for individual and independent manipulation by the control system.

72. A cutter-mixer-feeder (CMF) configured for producing, transporting and providing fodder comprising:
(a) a mobile platform;
(b) a chopper assembly for harvesting at least one raw material and for production of fodder therefrom;
(c) a container for storing at least one of the raw material and the fodder;
(d) at least one auger for chopping and mixing the fodder;
(e) at least one conveyer belt for distributing the fodder to an end user; and
(f) a drive unit configured for providing power for at least one of the above elements (a) to (e);
wherein, the chopper assembly comprises an elongated chopper member having a central axis and fitted with a spiral blade extending therealong around the central axis, and having a non-uniform pitch, wherein the distances between adjacent blade portions of the spiral blade increases inwardly, to thereby axially accelerate loose material from respective ends of the elongated chopper member towards a central portion thereof.
